(19) United States
(12) Patent Application Publication
(10) Pub. No.: US 2014/0074285 A1
(43) Pub. Date: Mar. 13, 2014

(54) DISPENSER APPARATUS WITH NETWORK CAPABILITIES AND METHODS FOR INSTALLING THE SAME

(71) Applicant: GOJO INDUSTRIES, INC., Akron, OH (US)

(72) Inventors: JACKSON W. WEGELIN, Stow, OH (US); MOHAMMADREZA SOUDMAND ASLI, Toronto (CA)

(73) Assignee: GOJO INDUSTRIES, INC., Akron, OH (US)

(21) Appl. No.: 14/024,680

(22) Filed: Sep. 12, 2013

Related U.S. Application Data
(60) Provisional application No. 61/700,424, filed on Sep. 13, 2012.

(51) Int. Cl. G06F 17/00

(52) U.S. Cl. CPC G06F 17/00
USPC 700/244; 709/223

(57) ABSTRACT

A network for a plurality of dispensers includes at least one dispenser device and a device controller carried by each dispenser device which monitors the operational activity of the dispenser device. A network transceiver is connected to each device controller and links to a gateway controller adapted to wirelessly communicate with each network transceiver. An installation button is associated with each network transceiver, wherein actuation of the installation button increases an operational duty cycle to enable linking of all of the dispenser devices to the gateway controller. Other embodiments are provided which facilitate learning of dispensers and related network devices to a network of dispensers.

### CROSS-REFERENCE TO RELATED APPLICATIONS

This application claims priority of U.S. Provisional Application Ser. No. 61/700,424 filed Sep. 13, 2012, and which is incorporated herein by reference.

### TECHNICAL FIELD

Generally, the present invention is directed to dispensers maintained in a network. In particular, the present invention provides a network device with an installation button to facilitate establishment of a dispenser network. Specifically, the present invention provides a network device where activation of the installation button starts an enhanced duty cycle to facilitate installation of the network device, such as a dispenser, into the network, thereby easing installation and saving power.

### BACKGROUND ART

It is well known to use fluid dispensers in public and semi-private settings. For example, fluid sanitizer dispensers are strategically located throughout hospitals, nursing homes and other health care facilities. Likewise, soap dispensers are positioned in all bathrooms of those facilities and in other public buildings and venues, such as restaurants.

In order to minimize the spread of germs and maintain a germ-free working environment, institutions may require employees to sanitize/wash their hands a predetermined number of times during a work shift. This may even include requiring the employees to wash their hands at predetermined times during their work shift. In order to provide evidence of compliance, each employee must carry an identifying sensor, a magnetic swipe card, or the like so as to ensure they use a compatible dispenser at the appropriate times. This provides for date and time stamps on the card which are then turned in at the end of the shift to a central computer or the use data may be retrieved directly from the dispenser.

Another way to monitor compliance is by linking the dispensers to a wireless network. The wireless network may be of various types and would still require the employees to use a dispenser in the network at an appropriate time. Some drawbacks of such a network are found in ensuring reliability of the network connections and in setting up the network. Examples of wireless networks include, but are not limited to star, tree, point-to-point, mesh and practical mesh.

It is believed that mesh networks are amendable for use with fluid dispensers. As understood, a mesh network functions to capture and disseminate its own data and also serves as a relay for other nodes or dispensers so as to propagate the data through the network. A mesh network can be configured utilizing a routing technique where the message or information travels along a path by hopping from node to node—dispenser to dispenser—until the destination is reached. To ensure redundancy, a routing map of the dispensers must allow for continuous connections and reconfiguration around broken or blocked paths. Still another type of network is a time synchronous network where all of the network components—end nodes, routers and hubs—utilize the same clock signal and sleep for a predetermined period of time.

One drawback of such networks is that they are sometimes difficult to install when a large number of dispensers are to be associated with a hub or controller of the network. In such a network, the hub only sends synchronization signals once every few minutes or so. Likewise, the dispensers themselves operate on a reduced duty cycle so that links between a dispenser to be installed and the other dispensers or the main hub of the network may take several hours. In previous installations all nodes had to stay on all the time, or at a minimum a network backbone of routers had to stay on all the time. For time synchronized networks, the nodes would need to be installed and then the technician would need to log into a gateway or hub computer and “wait” for the network to turn on and then travel back to each node and determine whether a connection has been made. Moreover, the prior art systems would not allow for network communications to confirm a connection at the installation point of a node, but instead would require a network log in to confirm installation. Therefore, there is a need in the art for a network device, such as a dispenser, a hub, or a handheld wand, and related network that allows for extended duty cycles only during installation or maintenance of the network device to ensure connectivity between other nodes or dispensers and a main gateway controller.

### SUMMARY OF THE INVENTION

In view of the foregoing, it is a first aspect of the present invention to provide a dispenser apparatus with network capabilities and methods for installing the same.

Another aspect of the present invention is to provide a method for establishing a time synchronized network, comprising initializing a gateway controller, positioning a plurality of network devices in relative proximity to one another and the gateway controller, actuating an installation button on at least one of the plurality of network devices so as to increase an operational duty cycle of a communication signal between the network devices and the gateway controller, and maintaining the increased operational duty cycle until all of the plurality of network devices are in linked communication with the gateway controller.

Yet another aspect of the present invention is to provide a network for a plurality of dispensers, comprising at least one dispenser device, a device controller carried by each dispenser device which monitors operational activity of the dispenser device, a network transceiver connected to each device controller, a gateway controller adapted to wirelessly to communicate with each network transceiver, and an installation button associated with each network transceiver, wherein actuation of the installation button increases an operational duty cycle to enable linking of all the dispenser devices to the gateway controller.

### BRIEF DESCRIPTION OF THE DRAWINGS

For a complete understanding of the objects, techniques and structure of the invention, reference should be made to the following detailed description and accompanying drawings, wherein:

FIG. 1 is a schematic diagram of a dispenser made according to the concepts of the present invention, wherein a cover of the dispenser is partially shown in phantom to show the dispenser's internal components;

FIG. 2 is a schematic diagram of a hub made according to the concepts of the present invention and used to establish a network;

FIG. 3 is a schematic diagram of a networking wand according to the concepts of the present invention and used to establish a network;

FIG. 4 is a schematic drawing of a network installation made in accordance with the concepts of the present invention; and

FIG. 5 is an operational flow chart showing an installation procedure for the network according to the concepts of the present invention.

### BEST MODE FOR CARRYING OUT THE INVENTION

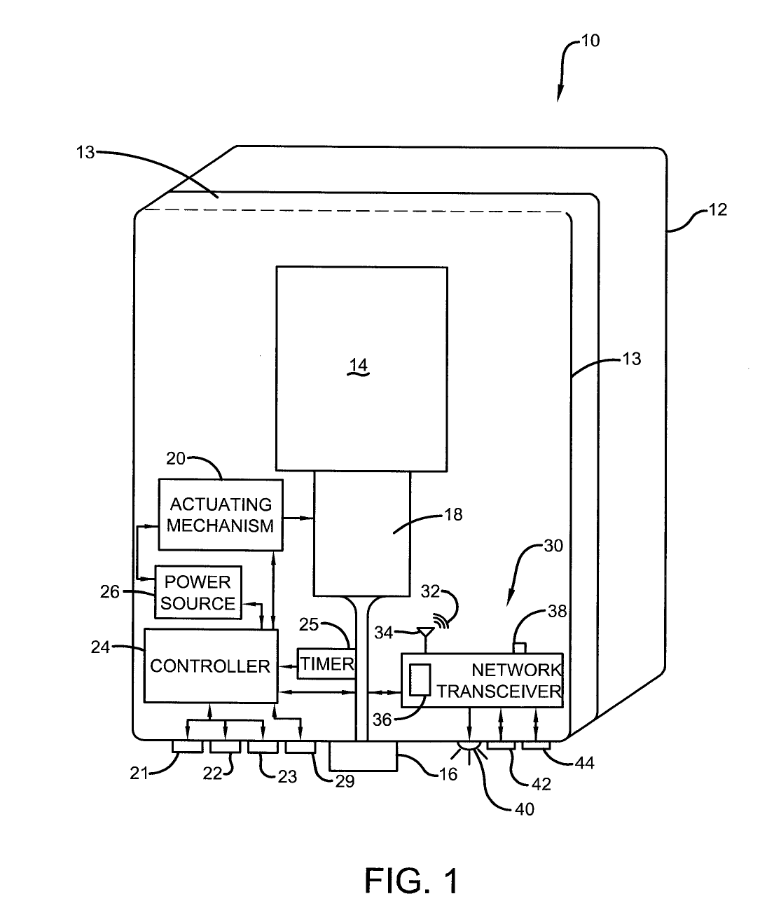

Referring now to the drawings and in particular to FIG. 1 it can be seen that a touch-free or manually actuated dispenser made in accordance with the concepts of the present invention and used in a network to be described is designated generally by the numeral 10. Although the concepts of the present invention are directed to a touch-free or hands-free dispenser, skilled artisans will appreciate that the present invention may also be utilized in any device that is associated with a wireless network and which is battery operated or uses power from a source other than conventional mains power to power at least one electrical component. In other words, the present invention may be utilized with any device which consumes power from a limited source. In any event, the dispenser 10 includes a housing 12 which provides a cover or door 13 that when open allows a technician to install or replace a refill container 14. The container 14, which may also be referred to as a cartridge, contains a fluid material such as a soap, a sanitizer or other material that is dispensed in measured amounts. The dispenser 14 may also dispense dry materials in powder or granular form or the like, pre-packaged materials, paper products or the like. Associated with the refill container 14 is a nozzle 16 which is a conduit from the container to an object receiving the fluid such as a user's hands or any other object upon which the fluid is dispensed. As used herein, the term “user” refers to a person or object detected by the dispenser so as to initiate a triggering event. In other words, the dispenser detects the presence of a user or an object in close proximity to where the fluid material or other product is dispensed and the dispenser determines that the user or object intends to receive the fluid. It will further be appreciated that a user may be a single person, or object that actuates the dispenser once or repeatedly, or multiple users or objects that are detected, one after the other. As such, a “second” user may in fact be the first user. In any event, the dispenser 10 includes a pump mechanism 18 which is interposed between the container 14 and the nozzle 16. The mechanism 18 is coupled to an actuating mechanism 20 such as a motor or solenoid that actuates the pump mechanism.

A proximity sensor 21 is associated with the housing 12 and may be in the form of an infrared, sonic, or capacitive type sensor which detects the presence of an object or the user's hands. An ambient light sensor 22 may be carried by the housing 12 for the purpose of determining whether lights in the area are on and/or whether it is daytime. Presumably, if sufficient ambient light is detected, indicating that it is daytime or that a light is on, the dispenser will likely be used more frequently. A motion detection sensor 23 may also be carried by the housing 12 for the purpose of determining whether potential users are moving in close proximity to the housing. If so, it is presumed that the dispenser will likely be used more frequently. Skilled artisans will appreciate that the sensors 21, 22 and 23 may be utilized to implement the hands-free or touch-free type dispensers. However, in some embodiments, the dispensers may be manually actuated.

A dispenser controller 24 is carried by the housing and is connected to the proximity sensor 21, the ambient light sensor 22, the motion detector 23, the actuating mechanism 20 and the pump mechanism 18. A timer 25 is connected to the controller 24 and may be used to facilitate the power management goals of the dispenser. The timer 25 may be able to track one or more events simultaneously and generate a signal indicating that a designated time period has expired. Skilled artisans will appreciate that all the functions needed to implement the timer may be incorporated or provided directly by the controller 24. As will be described, the ambient light sensor 22, the motion detection sensor 23, the timer 25 and any other device that detects some change in a physical characteristic or lapsing of time can be used to change an operational duty cycle of the proximity sensor and/or other component of the dispenser so as to reduce and manage power consumption of the dispenser.

A power source 26, which will be discussed in further detail, provides electrical power to the sensors 21, 22 and 23 via the controller 24; the controller 24; the pump mechanism 18; and the actuating mechanism 20. The power source 26 includes one or more batteries, which may be referred to as cells throughout the specification. The batteries used for the power source may be recharged by solar cells or by other means.

In general, the dispenser controller 24 and the appropriate sensor are used to control and manage the electrically powered components associated with the dispenser 10. These components include, but are not limited to the pump mechanism, the actuating mechanism, the sensor 21, the ambient light sensor 22, the motion detector 23 and the controller 24. It will be appreciated that the features of the dispenser 10 are applicable to other devices that are not dispensers or that are not hands-free dispensers or devices. Indeed, the present invention may be utilized with any device that relies on batteries or cells for power for extended periods of time. Generally, the controller 24 monitors operation of the sensors 21, 22 and 23, either singly or together, so as to manage and conserve the amount of power required to operate the dispenser. And the controller 24 may be configured to adjust operation during use to ensure a faster than normal response to input from users that indicate higher than normal usage.

A user input device 29 may be connected to the controller 24. The input device 29 may be in the form of a card reader, an RFID reader, a key pad, a wireless or infrared transceiver, or any device where a user can input information to the controller indicating that they are about to use the dispenser or how they would like to configure operation of the dispenser. In some embodiments, the input device 29 may also function as an invite button.

A network transceiver designated generally by the numeral 30 may be connected to the controller 24. Any activity related to the use and/or maintenance of the dispenser is communicated between the controller 24 and the network transceiver 30. This may include, but is not limited to, usage, an identification of the user, the date and time of the use, the number of times of use, actuation status, battery status, the amount of material or fluid maintained within the dispenser, and so on. The network transceiver 30 transmits and receives wireless signals, referred to herein as communications signals 32, at a predetermined frequency by an antenna 34. Associated with the network transceiver 30 is a display 36 which provides for information related to operation of the transceiver and the dispenser device 10. Also connected to the network transceiver 30 is an installation or “join” button 38 and its operation will be discussed at the description proceeds. A light emitting diode (LED) 40 is also connected to the network transceiver 30 for the purpose of providing a visual indication as to whether the network transceiver and thus the dispenser 10 is part of a network or not. An upload communication port 42 is provided for connection to the network transceiver so as to allow for a direct networking connection of the dispenser 10 to facilitate the joining of the dispenser to a network. A download communication port 44 may also be connected to the network transceiver. As will be discussed in further detail, the ports 42 and 44 allow for pre-configuration of a dispenser with other like dispensers into a network installation. When connected to a network of other dispensers, a single dispenser may be referred to as a “node.” In some situations, depending upon the structure of the network, a dispenser may be referred to as a master or a slave.

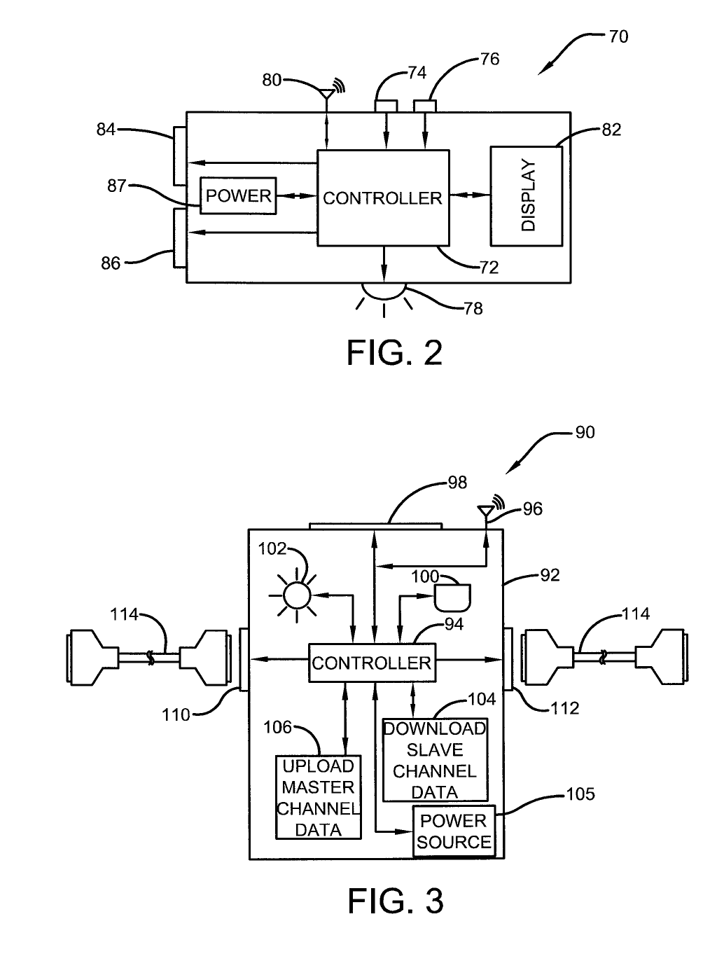

Referring now to FIG. 2 it can be seen that a hub is generally designated by the numeral 70. As will be described in further detail, the hub is typically associated with a number of dispensers 10 so as to coordinate their operation and provide for an additional connecting point in the network to establish reliability of transmission signals between the various dispensers, other hubs, and a gateway which will be described. The hub 70 includes a hub controller 72 which contains the necessary hardware, software and memory for implementation of the hub as will be described. An invite button 74 is connected to the controller, as is a join button 76. At least one light emitting diode (LED) 78 is connected to the controller to indicate a status of the hub. For example, one LED 78 may be used to indicate actuation of the join button, while another LED may be used to indicate actuation of the invite button. Other status indicators may be employed in place of the LEDs. An antenna 80 is connected to the controller 72 so as to allow for wireless communications to be sent and received by the hub. A display 82 may be connected to the controller to display various status indications of the hub and components in the network associated with the hub. A power source 87, which may be any type of battery, which may or may not be rechargeable, is connected to the controller 72 and is used to power all of the components of the hub. The hub may also be provided with an upload communication port 84 and a download communication port 86. Both ports 84 and 86 are connected to the hub controller 72. As with the dispenser, the ports 84 and 86 enable the hub or hubs to be pre-configured into a network installation. Skilled artisans will appreciate that the hub 70 may be incorporated into the dispenser 10, such that one dispenser functions as a “master” to other nearby dispensers that function as “slaves.” In such an embodiment, the hub 70 effectively replaces the network transceiver 30 maintained by the dispenser 10. As a result, in some embodiments a dispenser may perform as a hub.

Referring now to FIG. 3, it can be seen that a network wand is designated generally by the numeral 90. As will be discussed in further detail, the network wand 90 may be utilized to specifically learn dispensers (nodes) in a network to one another and/or to other hubs 70 contained within the network. The network wand 90 includes a housing 92 which maintains the internal components. In particular, the wand 90 includes a wand controller 94, which includes the necessary hardware, software and memory for incorporating the wand 90 into the network. The wand may also be used to allow the installation of dispensers into a network and/or the addition and removal of dispensers and/or hubs to an already existing network. An antenna 96 is provided by the wand and is connected to the controller 94. In some instances, a hard wire connection is desired for connection of the wand to components of the network and, as such, a port 98 is provided on the housing 92 and provides a direct electrical connection to the controller 94 by utilizing an appropriate interconnect cable. The port 98 and/or the antenna 96 may provide for a wired or wireless interface to allow for monitoring of the wand 90 and any hubs, dispensers and/or gateways which are part of the associated network and components in a network. A status button 100 is maintained on the housing 92 and is connected to the controller 94. The status button 100, when actuated, may cause the controller 94 to initiate specific routines or functions so as to allow for a determination of a status of the wand and/or the associated network. This may include a status determination of the dispensers, hubs and any other component on the network. The status button 100 may also be configured to perform other functions related to operation of the wand and configuration or installation of the network, and later modifications to the network. At least one light emitting diode (LED) 102 is also maintained on the housing 92 and is likewise connected to the controller 94. The LEDs may be used for various status indicators for the operation of the wand 90. The wand controller is connected to a display 104 that is connected to the controller so as to indicate up/down stream node connections. A power source 105, which may be any type of battery, which may or may not be rechargeable, is connected to the controller 94 and is used to power all of the components of the wand.

An upload button 106 and a download button 104 are each connected to the controller 94. As will be described, each of these buttons, upon actuation, joins an associated dispenser(s) or hub(s) to the network. In some embodiments, the wand 90 may be connected to a hub or a dispenser by interconnecting the wand controller 94 to the dispenser controller 24 via the port 98 on the wand, to either of the ports 42 and 44 and the network transceiver 30. In other embodiments, the wand 90 may be used to interconnect multiple dispensers and/or hubs to one another by use of the buttons 104 and 106 and an upload connection port 110 and a download connection port 112. Interconnection cables 114 may be used to initially connect and associate all the devices to one another for use in the network. Once all the devices are connected, the technician may actuate the button 106 which uploads all the pertinent information from the “upstream” connected devices. In a similar manner, actuation of the button 104 downloads all the pertinent information from the “downstream” connected devices. These upload and download operations effectively link each device to one another so that information from the dispenser furthest from a hub and/or a gateway reaches the gateway. Once all the interrelationships between the devices are learned, the devices are disconnected from one another and installed at their designated locations. Testing of the network may reveal that certain devices—dispensers and/or hubs—may need to be re-positioned in order for the network to function properly. In some embodiments, the ports 42, 44; 84, 86; and 110, 112 may be positioned on their respective devices so that they can be directly linked to one another without the need for cables 114. In still another embodiment, the respective ports could be replaced with infrared or other wireless communication links which would activate upon actuation of either buttons 104 or 106, or the appropriate invite and join buttons on the dispensers and/or hubs.

In order to link the various devices—dispensers, hubs, wands, etc.—to one another a time synchronous protocol may be utilized. It is desired that such a protocol operate with characteristics of low power consumption, which reduces the range or distance between the devices, but provides for improved latency. It is envisioned that each device will operate with about 0.5 msec transmission time and will be configured to wake up frequently, such as every 0.5 hz to 16 hz. Communications from device to device will be unidirectional. In other words, when a signal from a dispenser is directed to a hub or other central device in the network, the signal will be passed from one node to the next until the signal's final destination is reached. It is further envisioned that any number of devices could be used in the network. Protocols such as ANT provided by Dynastream Innovations Inc. of Cochrane, Alberta Canada, Bluetooth Low Energy (LE), or similar low energy protocols may be employed in establishing the network.

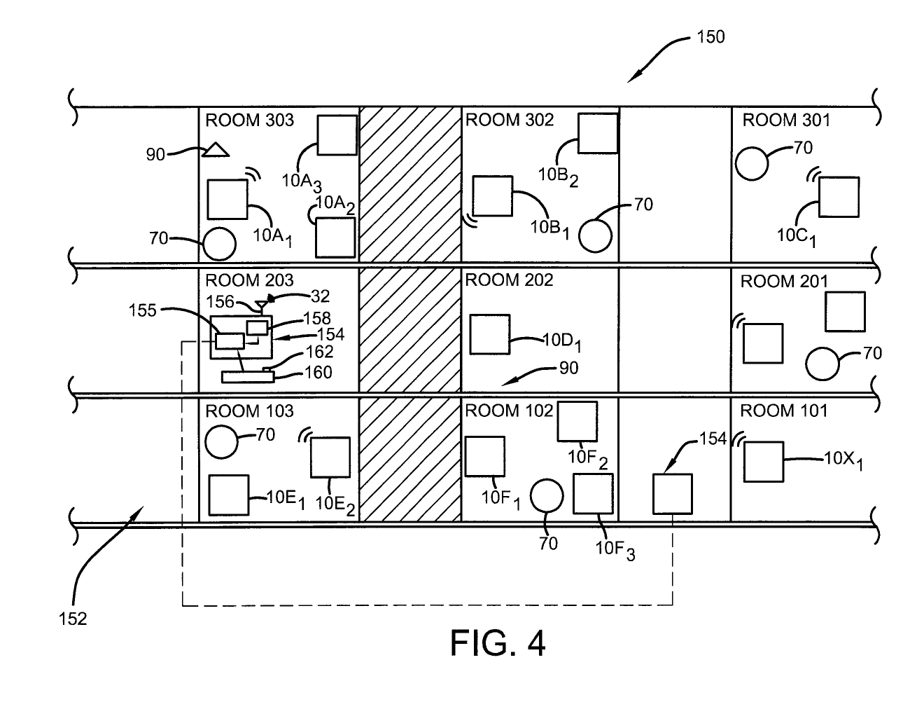

Referring now to FIG. 4, an exemplary use of a network dispenser 10 is shown. In particular, FIG. 4 shows a building 150, such as a hospital, which has a number of floors and many different rooms. It will further be appreciated that the building may be a single location, or a building among several like buildings on a campus, wherein one dispenser in one building may control or be linked with another dispenser in another building. In any event, a network designated generally by the numeral 152, which may be a time synchronous network or similar network, encompasses all of the dispensers 10 and/or hubs that may be in a single building or multiple buildings. The network 152 includes a gateway 154 that includes a gateway controller 155 which serves as the base for the network 152. Skilled artisans will appreciate that both controllers 24 and 155 include the necessary hardware, software and memory to implement the operation of the dispenser and network, singly and collectively, as described herein. The gateway controller 155 includes a network antenna 156 which communicates at an appropriate frequency band with at least one hub 70.

A display 158 is associated with the gateway controller 155 to provide for visual indication of the status of the network controller, the network 152 and the various operational statuses of the dispensers 10 and hubs 70 as needed. Each gateway controller 155 is provided with an input/output device 160 which allows for a technician to enter information into the controller and also obtain information related to the operation of the network 152. An invite button 162 is linked to the gateway controller 155 by the input/output device 160. The gateway 154 may be linked to other gateways.

So as to ensure that all dispensers, sometimes referred to as nodes, are maintained as part of the network 152, the hospital rooms may contain at least one hub 70, wherein each hub, which could also be a node, is associated with one or more of the dispensers. As shown in FIG. 4, Room 303 has one hub 70 associated with three dispensers, whereas room 302 has a hub 70 associated with only two dispensers. Any number of nodes can be configured in the network 152.

When installing the nodes or dispensers 10 and/or the hubs 70, it will be appreciated that a skilled technician may utilize the networking wand 90 so as to determine which nodes are in range and it may also be used to program which node is associated with a hub and, accordingly, which hub is associated with a gateway 154. And, as discussed, in one embodiment the wand may be used to pre-configure the network by allowing all the devices to be initially connected to one another, actuating the upload and download buttons, and then installing the devices in their desired location.

In another embodiment, the joining of dispenser nodes to a hub is accomplished by first pressing the invite button 74 on the hub and then pressing the join button 38 on each dispenser to be associated with the hub. Confirmation of the joining of a dispenser to a hub is then indicated by illumination of the LED 40 on each dispenser. If for some reason the connection between a hub 70 and the dispenser is not desired, the technician can actuate the invite button again to cancel the linkage between the hub and the dispensers.

Using a similar procedure other embodiments allow for linking multiple dispensers to a hub, linking dispensers to one another and/or linking hubs to hubs. In order to link multiple dispensers to a hub, the invite button 74 is actuated first and the join button 38 for all the dispensers to be linked to the hub are subsequently actuated. In some embodiments a time limit, such as one minute, for actuating the join buttons after actuating the invite button may be required. In order to join multiple dispensers to one another, an invite button, which may be provided on the input device 29, on a first dispenser is pressed and then a join button 38 on a second dispenser, which is in range of the first dispenser, is pressed. In such an embodiment, the actuation of the invite button causes the controller 24 associated therewith to function as a network controller to allow for linkage with other dispensers. This establishes a communications link between the two devices and any device previously linked thereto or linked in the future. In an alternative embodiment, two dispensers may be linked to one another by first pressing a join button on the first dispenser and then pressing a join button on the second dispenser. In order to link hubs to one another a similar process can be used. First, the invite button on a first hub is actuated and then the join button on a second hub is actuated to join the hubs to one another. In some embodiments, a time limit, such as one minute, may be required to join hubs to one another.

In order to link the hubs and/or dispensers to the network or gateway device, an invite button 162 on the gateway controller 154 is actuated and then the join button 76 on the hub 70 or the join button 38 on the dispenser is actuated. In some embodiments it will be appreciated that all the upstream connections to one hub or dispenser are automatically transferred to the gateway controller. In other embodiments, the wand 90, after it has been associated with the various upstream and downstream components, is linked to the gateway controller through either the input/output device 160, or the network connection data could be transferred through the antennas 96 and 156. Confirmation that the hubs and dispensers are linked to the gateway may be made by illuminated their respective LEDs for a designated period of time or on the displays if provided. In this manner, various network devices such as the dispensers, hubs, and/or wands, may be linked to one another and the gateway controller so as to install and operate a network comprising the aforementioned devices and any other compatible device. In a similar manner, the controllers 24, 72 and 94 associated with the dispensers, hubs and wands may be generically referred to as a network or device controller, any one or all of which may be linked to one another and the gateway controller.

In normal operation the gateway controller operates to send a synchronization signal once about every three minutes. Of course, other synchronization timing signals may be sent as appropriate. The duty cycle is established so as to provide for adequate data collection while also minimizing the need for sending out signals and maintaining a minimal power consumption for the power source of the network controller and the power source for each of the linked dispensers.

As will be appreciated, the gateway controller 154, when sending synchronization signals, generates or broadcasts a signal so as to be received by a multiple number of dispensers such as 10A, 10B and so on. Although it is envisioned that the gateway controller will send out a relatively strong signal, it will be appreciated that the network operates by virtue of a dispenser(s) sending a signal to the associated hub which in turn sends a signal to an adjacent hub, which also receives signals associated with that hub. All these signals are collectively passed from hub to hub until the signals reach the gateway controller. In this way, the various dispensers are linked to one another.

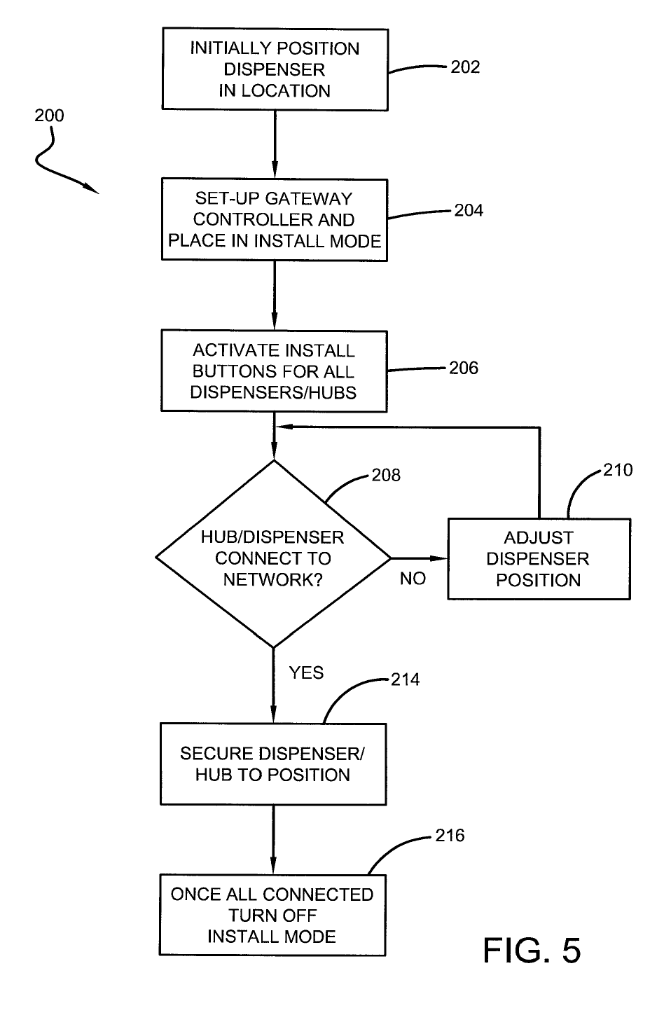

Referring now to FIG. 5, it can be seen that an operational flow chart for installing and managing the time synchronous network is designated generally by the numeral 200. Once the gateway controller 154 is installed and able to send and receive signals via the network antenna 156, each of the dispensers 10 and hubs 70 are initially positioned in a desired location at step 202. It will be appreciated that positioning of any dispenser in the network may be constrained by various openings in the building where building structure may interfere with signals being emitted and received by the dispenser and the like. In some embodiments this may also include learning dispensers and hubs to one another with the wand 90. At step 204, the gateway controller is set in place and put into an install mode for communicating with the various dispensers and hubs. In some instances, the wand 90 may be linked directly to the gateway controller so as to learn the relative positions of the dispenser and/or hubs to one another. Next, at step 206, the installation button 38 for each of the dispensers 10 is activated so as to increase the normal duty cycle from an operational cycle to an installation cycle. In most embodiments, the installation cycle wakes up at least every two to five seconds. In some embodiments, the installation cycle may be once per second. As such, the dispenser in the installation cycle is continually sending and receiving signals for communication with the other dispensers and the network transceiver 30.

Next, at step 208, the installer determines whether a subject dispenser, for example dispenser 10X in room 101, via the network transceiver 30 is connected or linked to other hubs and/or dispensers in the network and, as a result, to the gateway controller 154. If not, then at step 210 the dispenser is positionally adjusted to determine whether a connection is made to another dispenser or dispensers and whether that connection is reliable or not. After an adjustment of the position of the dispenser is performed at step 210, the process returns to step 208 to re-determine whether the dispenser is connected to the network or not. After it is determined by viewing the display 158 or an indication provided by the dispenser that a connection is made to the gateway controller, relative positions all or selected dispensers or hubs are set at steps 208 and 210, the process continues to step 214 where the technician secures the dispenser position at the desired location and then at step 216 all the dispensers that are connected into the mesh network are returned to an operational mode from the installation mode so as to reduce the duty cycle from one hundred percent to the desired level and conserve power as appropriate.

Based upon the foregoing, the advantages of the present invention are readily apparent. It will be appreciated that by temporarily increasing the duty cycle during the installation mode that the disclosed dispenser and network provides for the ability to rapidly confirm connection of each network node. As such, the installation time period until a time synchronous network for dispensers is fully populated is significantly reduced. This ensures that the installer may provide for more than one path of communication during the installation process or for later troubleshooting. Skilled artisans will appreciate that by implementing such a method overall power consumption is reduced and the ease of installation is greatly improved.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

1. A method for establishing a time synchronized network, comprising:
initializing a gateway controller;
positioning a plurality of network devices in relative proximity to one another and said gateway controller;
actuating an installation button on at least one of said plurality of network devices so as to increase an operational duty cycle of a communication signal between said network devices and said gateway controller; and
maintaining the increased operational duty cycle until all of said plurality of network devices are in linked communication with said gateway controller.

2. The method according to claim 1, further comprising:
re-positioning each said network device until in linked communication with said gateway controller.

3. The method according to claim 1, further comprising:
re-positioning each said network device until in linked communication with said gateway controller by two different communication paths of linked network devices.

4. The method according to claim 3, further comprising:
securing said network device in place.

5. The method according to claim 3, further comprising:
displaying on said network device each different communication path to said gateway controller.

6. The method according to claim 5, further comprising:
securing said network device in place.

7. The method according to claim 6, further comprising:
changing said operational duty cycle on all said network devices when all are linked to said gateway controller.

8. The method according to claim 2, further comprising:
providing a fluid dispenser as at least one of said network devices.

9. The method according to claim 8, further comprising:
providing at least one hub as at least one of said network devices, wherein a plurality of said fluid dispensers are linked in communication with said hub.

10. The method according to claim 2, further comprising:
providing a wand as at least one of said network devices;
providing a plurality of fluid dispensers as said network devices; and
linking said plurality of fluid dispensers to said wand prior to actuating said installation button.

11. The method according to claim 1, further comprising:
actuating an invite button prior to actuating said installation button so as to initialize said network controller.

12. A network for a plurality of dispensers, comprising:
at least one dispenser device;
a device controller carried by each said dispenser device which monitors operational activity of said dispenser device;
a network transceiver connected to each said device controller;
a gateway controller adapted to wirelessly communicate with each said network transceiver; and
an installation button associated with each said network transceiver, wherein actuation of said installation button increases an operational duty cycle to enable linking of all said dispenser devices to said gateway controller.

13. The network according to claim 12, further comprising:
a display connected to said device controller to confirm connection to said gateway controller.

14. The network according to claim 13, wherein said display provides information as to connection paths, said dispenser devices, and said gateway controller.

15. The network according to claim 12, wherein said operational duty cycle is increased to 100% when said installation button is actuated.

16. The network according to claim 12, further comprising:
a wand to initially link said dispenser devices to one another prior to actuation of said installation button.

17. The network according to claim 12, further comprising:
an invite button associated with said device controller, wherein actuation of said invite button for a first dispenser and actuation of said installation button of a second dispenser enables linking of said first and second dispensers to one another.
